(19) United States
(12) Patent Application Publication
(10) Pub. No.: US 2024/0340323 A1
(43) Pub. Date: Oct. 10, 2024

(54) REAL-TIME AUDIO-VIDEO STREAMING SYSTEM

(71) Applicant: eLive GmbH, München (DE)

(72) Inventors: Till KAESTNER, München (DE); Rüdiger LINHOF, Germering (DE); Christopher FURTNER, München (DE)

(21) Appl. No.: 18/293,961

(22) PCT Filed: Aug. 4, 2022
(86) PCT No.: PCT/EP2022/072019

§ 371 Date: Jan. 31, 2024

(30) Foreign Application Priority Data
Aug. 4, 2021 (DE) 102021120330.9

(51) Int. Cl. H04L 65/403; G06F 3/16; H04L 65/80; H04N 5/265; H04N 5/268; H04N 23/62; H04R 1/40; H04R 3/00

(52) U.S. Cl. CPC H04L 65/403; G06F 3/162; G06F 3/165; H04L 65/80; H04N 5/265; H04N 5/268; H04N 23/62; H04R 1/406; H04R 3/005

(57) ABSTRACT

A real-time video streaming system is provided that comprises a presenter side system, an audience side system that is remote from the presenter side system and at least one control console that is remote from both, the presenter side system and the audience side system. The presenter side system comprises a sound mixer with a control interface for remotely controlling the sound mixer via the control console.

The invention relates to a bi-directional real-time audio-video streaming system.

Real-time audio-video streaming systems are inter alia used for video conferencing. In such system, video and audio signals are captured by one or more microphones and cameras, analog-to-digital converted and encoded before being transmitted as an audio-video data stream over a data communication network such as the internet. In a receiving system, the audio-video data stream is decoded and the audio and video signals are played back via one or more displays and loudspeakers. For video-conferencing, systems are configured to generate and transmit audio-video data streams and to receive data stream in real time with low latency to thus allow for a communication between persons that each use such system while the systems are interconnected via the internet. For video conferencing, low-latency bidirectional audio-video live streaming is used between two or more locations. At each location audio video signal recording, analog to digital conversion, encoding and data transmission as well as data reception, decoding, digital to analog conversion and playback of thus received analog audio and video signals occurs.

Video conferencing systems only provide a limited quality of sound and video depending on the quality, in particular the bandwidth, of the data connection between the systems.

Quality of video conferencing systems is typically lower than the quality that can be achieved in TV broadcasting because they are designed to be operated automatically, highly standardised. Professional live events or broadcasts require professional audio, video and broadcast engineers to individually produce the required quality & stability and to supervise & troubleshoot in case of issues like software, hardware or connection errors. TV broadcasting is unidirectional while video conferencing is bi directional.

It is an object of the invention to provide a bi-directional real-time audio-video streaming system providing a good audio and video quality while relieving a performing user from technical and control tasks and keeping the system for the user at a “plug & play” level of minimum complexity.

According to the invention, this object is achieved by a system that provides interfaces for external access to technical components and production interfaces, (hardware and software tools) so that technical experts like audio/video or streaming/connectivity engineers can provide services to the performing presenters who uses a presenter side system as disclosed herein.

The system offers an interface to external content sources and/or computers and/or devices providing additional input and/or audio and/or video content, which can be mixed with or blended into the live performance. This way presenters can enrich their appearance and/or/presentation. Further, the audiences can give feedback.

According to the invention, a real-time video streaming system is provided that comprises a presenter side system, an audience side system that is remote from the presenter side system and at least one control console that is remote from both, the presenter side system and the audience side system.

The presenter-side system comprises
at least one video camera,
a plurality of microphones and/or sound pick-ups,
a sound mixer with a plurality of audio signal inputs and at least one audio signal output,
a streaming data gateway including a video signal interface and an audio signal interface and comprising a codec for generating a digital video stream to be transmitted via a data network, said video stream representing video signals recorded by the camera and audio signals representing signals provided by the sound mixer,
a remote control gateway for remotely controlling the sound mixer, plus other functions of the presenter-side device
an audio mixing control system remotely connected to the presenter-side system comprising a remote control console for remotely operating the sound mixer, by a professional sound engineer
an audience-side system comprising a digital signal receiver comprising a codec for decoding the digital video/audio stream and a video screen and/or projector and loudspeakers at least indirectly connected to the digital signal receiver.

The sound mixer is a professional audio processing unit, which mixes audio signals and processes audio signals/quality to achieve a professional sound production.

The mixing control room that is remote from both, the presenter-side system and the audience-side system enables a professional remote audio production that is controlled by a professional sound engineer without needing a sound engineer at the presenter side.

While in video conferencing both sides are connected via a fully automated direct server connection, the invention includes manually operated access to server functions to enable a customized professional remote production (as well as access to hardware and software on both sides) operated by professional engineers. Thus it is possible to produce a presentation in a virtual live format that can be presented to the audience as a remote live performance that creates at the audience a live-feeling including goose-bumps similar the a live act where the presenters and the audience meet in person. A professional PA system at the audience-side system can improve the live experience. However, a professional remote production as provided by the system according to the invention provides all what is needed for such a production without requiring a sound engineer at the presenter-side system or the audience-side system.

By means of the real-time video streaming system, a method of remote production of a live-like presenter's act can be performed by enabling manual expert services to be performed remotely through interfaces to local systems and backend functionalities on servers. The method comprises
performing a live-act at a presenter-side location
converting sound signals of the live act in to digital sound signals
mixing the digital sound signals by means of a remote controlled digital sound mixer
remotely controlling the digital sound mixer by means of a remote control console in a mixing control room at a location that is remote from the location of the live act
streaming the mixed audio stream generated by the digital sound mixer to the mixing control room and the an audience-side system at a third remote location and
technical supervision of production, connections, signal routing (e.g. re-routing of internet connections) and technical systems (presenter/audience and server functions/software solution)
providing the remote live act to an audience at the remote audience-side system's location.

The audience-side system preferably is also connected to the audio mixing control room and preferably a master control room (MCR).

The audience-side system preferably further comprises one or more cameras and microphones in order to provide a bi-directional audio-video live connection and experience.

The streaming data gateway preferably is incorporated in a presenter side signal-processing device comprising audio and video signal interfaces and one or more digital data interfaces, at least one of them being connected to a modem for generating, transmitting and receiving data streams.

The streaming data gateway preferably is configured for bi-directional audio video data streaming. Accordingly, the streaming data gateway preferably comprises a bidirectional data modem for transmitting and receiving data signal streams. The data modem is connected to a decoder for decoding an audio video signal data stream received via the data modem.

The streaming data gateways on presenter-side as well as audience-side preferably are connected to a streaming server, which is located in a datacenter and can be accessed by the master control room and their technical services engineers through secured internet connections (VPN/IPsec).

Preferably, for each microphone and/or pick-up, an analog preamplifier and an analog to digital converter are provided. When in use, analog audio signals generated by the microphone and/or pick-up are fed to the analog preamplifier and the preamplified audio signals are analog to digital converted to thus generate digital audio signals. The digital audio signals can be fed as input signals to the sound mixer. Further, the digital audio signals can be fed to the remote mixing control room to thus enable a sound engineer in the remote mixing control room to listen to selected individual sound signals from a microphone or a sound pick-up and individually apply audio processing.

The video camera in the presenter-side system preferably is a digital video camera that provides a digital video signal stream when in use.

The sound mixer preferably is a digital sound mixer having a plurality digital audio signal inputs. The sound mixer further has a digital control interface and is configured to be remotely controlled by control signals received via the digital control interface. The digital control interface is part of the control gateway of the sound mixer. The control signals for the sound mixer are provided by the remote control console that is operated by a professional sound engineer.

Preferably, the sound mixer is configured for mixing a plurality of audio signal streams. The mixed audio signal stream generated by the mixer from the plurality of audio signal streams is fed to both, a server that is controlled by the control console in the master control room, and from the server to the audience-side system (via a digital signal router) and to the mixing control room to thus enable a sound engineer in the mixing control room to listen to the mixed audio signal stream generated by the mixer.

Optionally, the sound mixer is integrated in the signal processing device.

In a preferred embodiment, a master control room or signal routing control room for controlling data transmission (for instance routing etc.) and other technical functions (for instance video signal selection and mixing) can be provided for remotely controlling e.g. the streaming data gateway and the video cameras. The master control room allows supervising all productions and thus typically is always part of a production. The master control room comprises a control console for controlling signal selection and signal routing of signals to be streamed to the audience-site system. An operator in the master control room preferably can also provide video engineering services via the signal routing control console. This may include controlling the cameras and the selection of video signals provided by the cameras for streaming to the audience-site system. Controlling the cameras preferably includes controlling the orientation of the camera, the zoom of an individual camera and the focus of an individual camera. Via the control console, an operator can also add overlays to the video images to be streamed to the audience-site system. Acting as a video engineer, an operator may also do vision mixing and can apply visual effects to the video signals to be streamed to the audience-side system. Further tasks that can be performed by the operator in a preferred master control room include
vision mixing (i.e. the editorial decision which camera's video signal is streamed live) in order to create the best live-experience while showing the ROI (Region of interest),
video engineering and processing (matching and processing of the camera views) and
color and ISO (exposure) matching via processing tools for the cameras inside the backend server.

The master control room of the preferred embodiment serves for controlling functions like router/onboard computer and overseeing the streaming server/connectivity and other internet connections (VPN/IPsec). The control console of the master control room preferably is connected to a backend server. An operator in the master control room can thus control the backend server and the signal processing and routing depending on, for instance, quality of service of the streaming service.

In the presenter-side system, preferably one or more lightning devices and devices for remotely controlling the lightning devices are provided.

Further, in the presenter-side system preferably monitoring loudspeakers and further preferred a video screen are provided which allows for life-size projection of the video signals. The projection method can be near-field projectors but also VR devices as well as holograms in the future. The monitoring loudspeakers can be part of in-ear monitors for a presenter or can be provided in form of loudspeaker boxes. The monitoring loudspeakers are preferably connected to the streaming data gateway. In such setup, the streaming data gateway preferably is connected to amplifiers that are in turn connected to the monitoring loudspeakers. Alternatively, or additionally, the streaming data gateway may be configured to wirelessly transmit audio signals to the monitoring loudspeakers.

Cameras and microphones from mobile cameras can be logged into the streaming server to provide additional video and audio sources for the mix the audience side receives.

Preferably, in the presenter-side system a mobile device can be logged in that is configured to provide a user interface for operating the different video and/or audio and/or additional content sources in the presenter-side system and those directly connected to the streaming server. This device can also remotely control server functions, which enhance the live presentation.

The mobile device preferably is further configured to provide a user interface for remotely controlling the controllable lightning devices in the presenter-side system. Those as well as the audio mixer can be controlled remotely through a secured external internet connection (VPN/IPsec) to the presenter-side system

The streaming data gateway preferably is configured to use Transmission Control Protocol (TCP) or the User Datagram Protocol (UDP) as protocol for the signal transport layer for audio video signal data streaming.

The streaming data gateway preferably is configured to use, WebRTC (Web Real-Time Communication protocol), RIST (Reliable Internet Stream Transport), and SRT (Secure Reliable Transport) as live audio video streaming protocol.

The streaming data gateway preferably is configured to provide one or more of the following codecs for digital video signal encoding and decoding: VP8, VP9, H.264 and H.265.

The streaming data gateway preferably is configured to provide one or more of the following codecs for digital audio signal encoding and decoding: AAC, Opus, AIFF and LAC.

Audio and video content from a product website can be included into the audio and video mix of the live performance. Presenters can customize their web profile and provide audio and video content, which can be mixed into the live performance. Audiences can also use web applications to provide feedback during the live performance, which will be displayed to the presenter by including the content into the video mix for the presenter

On top the direct internet connection between presenters and audiences the presenter side system can be configured to create artefacts from the live experience like autographs, pictures, even physical objects which can be augmented by e.g. laser printing/engraving or 3D printing. To do that the presenter connects devices to the presenter-side system to create the artifacts. The audience-side system connects to devices which can then produce the artifacts. For producing those artifacts during a live act the presenter side system preferably comprises at least one artifact production device such as a 3D-printer. Additionally or alternatively, the presenter side system may comprise a non-fungible token (NFT) generator that can generate and assign non-fungible tokens to an artifact. Artifacts may include recordings of a live act and/or autographs from an artist created during the live act. For creating autographs during a live act at the presenter side system, a mobile device and a stylus may be provided. Autographs thus created can be provided with a non-fungible token and transmitted to the audience side system.

The invention shall now be further illustrated by way of example, referring to the FIGURES of which

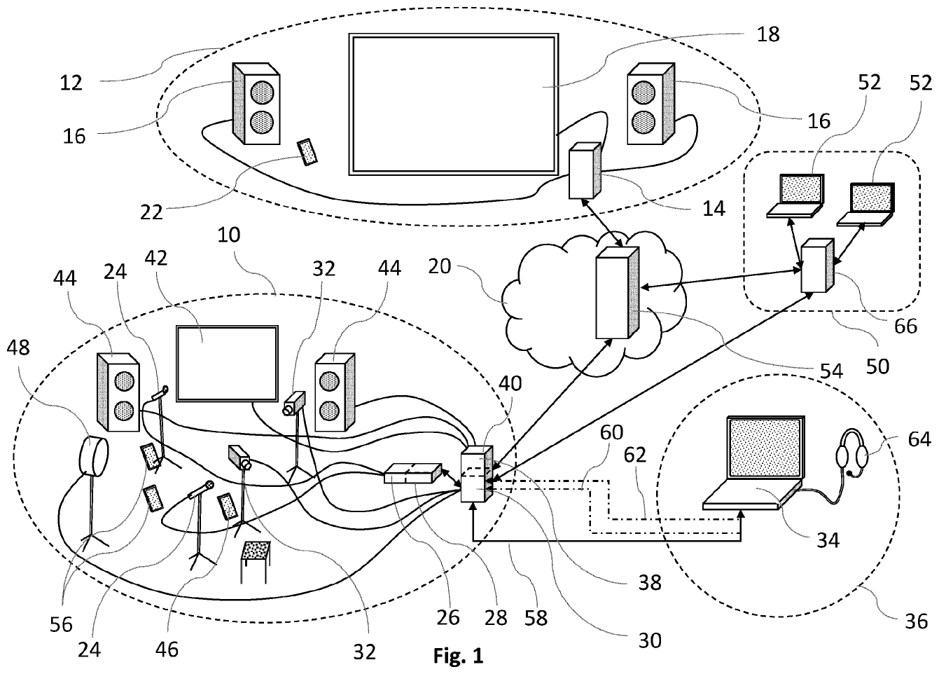

FIG. 1: is a schematic representation of a system according to the invention.

The system serves for high quality live streaming of a presenter performance to an audience. The system comprises a presenter-side system 10 for recording a live act performed by one or more presenters or actors or the like and an audience-side system 12 where an audience can remotely follow the live act. The system comprises a remote audio mixing control system that can be arranged in an audio mixing control room 36. The remote audio mixing control system comprises a remote control console 34 for remotely controlling mixing of audio signals generated at the presenter side system 10.

The audience-side system is equipped with live stream receiver 14 that is connected to loudspeakers 16 and a screen 18. The live stream receiver 14 is configured to receive a live stream via a data communication network 20 such as the internet, to decode the live stream, thus generating audio and video signals and to play back the audio and video via the screen and the loudspeakers. It is noted that the live stream receiver 14 can be a smart phone, a laptop or audio-video home studio with a streaming receiver, separate loudspeakers and a large scale screen. Accordingly, the live stream receiver 14 comprises a data interface, a decoder, a digital to analog converter (DAC) and one or more amplifiers.

Further, a microphone and preferably a camera are provided in the audience-side system. The microphone and the camera are connected to a transmitter for transmitting a live stream from the audience-side system to the presenter-side system. Thus, the audience can provide live-feedback the performing presenter(s) like in a video-conferencing system. Again, the microphone, the camera and the transmitter can be incorporated in a smartphone 22.

Accordingly, a smartphone 22, a tablet or a laptop computer are a kind of a minimum equipment of the audience-side system. Thus, a live act can be played back in the audience-side system and the audience can provide live feedback to the performing presenter(s). The audience-side system can be any space remote from the presenter-side system.

In a preferred embodiment, the audience-side system 12 comprises PA-equipment (PA: public address) that is capable of producing a sound pressure similar a sound pressure that is generated for the audience of a live-act of the presenters.

While the audience-side system 12 and its equipment does not necessarily require any special equipment, it is the object of the invention to provide a high quality live stream from the presenter-side system to the audience-side system and to generate a listening experience similar to a live-act.

The desired effect is achieved by providing means for dedicated sound mixing in the presenter-side system 10 that can be remotely controlled by for instance a sound engineer. Thus, a sound engineer can perform a professional sound mixing and possibly apply sound effects such as booster, chorus, compressor, delay (echo), distortion, flanger, fuzz, octaver, overdrive, panner, phaser, reverb (hall), ring modulator, rotary (leslie), slicer, slow gear (swell), tremolo, uni-vibe, vibrato, (auto) wah-wah ad/or whammy. For professional sound mixing, a remote control console 34 is placed remotely from the presenter-side system 10 in a mixing control room 36. A sound engineer in the mixing control room 36 can listen to the mixed sound signal generated by the mixer 30 and to a sound channel providing sound signals from individual microphones or pick-ups. From the mixing control room 36 to the presenter-side system 10, a control channel 62 for remotely controlling a mixer 30 and a communication channel 60 for communicating with the presenter(s) at the presenter side system 10 are provided. From the presenter-side system 10 to the mixing control room 36, audio signal channels are provided via a bi-directional audio and/or video connection 58. The audio signal channels include at least one mixed audio signal channel for the mixed audio signal generated by the mixer 30 and a further audio signal channel that can forward at least one of the mixer input audio signals (i.e. audio signals from microphones or pickups at the presenter side system 10) to the mixing control room 36.

Sound effects can either be applied by the sound engineer via the remote control console 34 and the sound mixer 30 or by an individual artist that operates for instance a flange or any other individual sound effect device.

In the presenter-side system 10, one or more microphones 24 and/or audio signal pick-ups are provided. Each microphone 24 and/or pick-up is connected to an analog preamplifier 26 that in turn is connected to an analog to digital converter 28. Thus, acoustic audio signals captured by a microphone 24 or a pick up a first converted into electrical audio signals that in turn are preamplified and analog to digital converted to thus generate digital audio signals.

The digital audio signals are fed to a digital mixer 30 for mixing digital audio signal streams received from the microphones 24 or pick ups via a respective preamplifier 26 and analog to digital converter 28. The mixer is remotely control by means of the console 34 in the mixing control room 36.

In the presenter-side system 10, also a digital video camera 32 is provided that generates digital video signals. Thus, the digital video camera 32 provides a digital video signal stream that can also be fed to the digital mixer 30 for mixing the digital audio signal streams and the at least one digital video signal stream.

The digital mixer 30 comprises a digital control interface for receiving digital control signals from the remote control console 34. Thus, the mixing of the digital audio signal streams and the at least one digital video signal stream in the digital mixer can be remotely controlled by the remote control console 34. Preferably, the remote control console 34 is placed remotely from the presenter-side system in the mixing control room 36.

The digital mixer 30 generates a digital audio video data stream that can be transmitted to the audience-side system 12. The digital audio data stream generated by the mixer is also transmitted to the mixing control room 36 to thus enable a sound engineer to listen to the mixed audio signal for instance by means of a head set 64. The head set can be connected to the remote control console 34 (as shown in FIG. 1) or to a dedicated digital headphone amplifier. In the latter case, the audio signal received via the audio signal channel 62 can be routed via the remote control console or be directly fed to the headphone amplifier. The remote control console 34 and/or the headphone amplifier can comprise a sound signal selector to enable the sound engineer to select a sound signal, for instance the mixed sound signal generated by the mixer 30 or a sound signal from an individual microphone or pick-up. The remote control console 34 and/or the headphone amplifier can comprise a digital-to-analog converter for converting digital sound signals to analog (electric) sound signals and an amplifier for amplifying the analog (electric) sound signal to a level suitable for the head set 64.

In the illustrated embodiment the signal processing device 40 of the presenter-side system 10 only transmits the mixed audio signal stream and the video signal streams from the video camera(s) connected to the signal processing device 40 of the presenter-side system. The eventual video mixing and selection of video and audio channels to be transmitted to the audience-side system is performed on a streaming server 54, which is hosted in a data center. Additional audio and video sources can be provided using any smartphone with camera and microphone and internet connection, which logs in to the streaming server in the datacenter directly.

For transmitting the digital audio-video data stream, the digital mixer 30 is connected to a streaming data gateway 38 that preferably is incorporated in a signal processing device 40 that comprises a modem for generating, transmitting and receiving data streams. The signal-processing device further comprises encoders and decoders (codecs) for encoding and decoding audio video data streams to be transmitted via the modem or being received by the modem.

The signal processing device 40 preferably is configured for using either the transmission control protocol (TCP) or the user datagram protocol (UDP) as a protocol for the signal transport layer for audio-video single data streaming. Further, the streaming data gateway preferably is configured to use RTMP (real-time messaging protocol), web RTC (web realtime communication protocol, FTL (faster than light protocol) and/or SRT (secure reliable transport) as a live audio-video streaming protocol.

As pointed out, the digital mixer 30 and the streaming data gateway 36 are preferably incorporated in a single data processing device 40. The sound mixing by the digital mixer 30 in the data processing device 40 is remotely controlled from a remote control console 34 in the mixing control room 36. The remote control console 34 in the mixing control room 36 can be connected to different data processing devices 40 at different remote locations. Thus, a professional mixing service can be provided for various locations while needing only one mixing control room. Remotely controlling different data processing devices 40 including mixers 30 from a central mixing control room is core feature of a remote production system.

Since the digital mixer 30 can be remotely controlled by the console 34 in a remote location, i.e. a mixing or master control room (MCR), a plurality of different presenter-side systems can be equipped with such single processing device 40. Thus, presenters can for instance use their rehearsal studio as a presenter-side system and only need to install the signal processing device 40 for benefiting from professional sound mixing and high quality audio-video live streaming since the digital mixer of the signal processing device can be remotely—and thus centrally—controlled by a professional audio engineer via the control console.

Presenters, for example a music band, only need to rent or buy one such signal processing device in addition to the equipment typically provided in a rehearsal studio. The presenter are relieved from signal mixing because signal mixing is done by the digital mixer in the signal processing device, said digital mixer being remotely controlled by a professional sound engineer. Of course, the professional sound engineer and the presenters together can perform a professional sound check prior to a live act to be streamed to the audience-side system.

For the sound check, the audio engineer is connected to the presenter-side system using the dedicated and bi-directional audio and/or video connection 58. Hence, the band can see the sound engineer and communicate with him or her during sound check. The sound engineer can hear the audio channels (audio signal streams provided by the microphones and/or pick-ups) and the final audio mix.

The same connection applies to the technical support engineer in the control room for controlling video signal mixing and streaming in the streaming server.

Then, the presenters can easily perform a live act that is live streamed to the audience-side system 12. During the live act audio and video signal, mixing is professionally controlled by a remote sound engineer via the remote control console 34 without requiring any action from a presenter. Thus, the presenters can perform like in a live concert while relying on a professional remote production.

Since the streaming data gateway of the signal processing device is bidirectional, feedback from the audience can be live streamed to the presenter-side system and played back via a screen 42 and loudspeakers 44 in the presenter-side system. Thus, the presenters in the presenter-side system can experience the reaction and the feedback of the audience in near real-time and life-size during the live act. Of course, a presenter can directly address the audience or the audience could also directly address a presenter.

To facilitate such type of interaction, in the presenter-side system preferably a mobile device 46 is provided for controlling the digital video camera 32. Thus, a presenter is able to control switch on/off and between the digital video cameras and audio channels for interacting with the audience or performing sound check.

In addition, lightning equipment including lightning devices 48 preferably can also be remotely controlled by such mobile device or from the remote console. Accordingly, the mobile device 46 is configured to provide a user interface for controlling the digital video camera 32 and the lightning equipment 48 in the studio. In addition, the mobile device can also be configured to interact with the digital mixer 30 to thus allow a direct control of the mixing in addition to the remote control of the mixing by the professional sound engineer.

In order to provide high quality live stream, preferably a master control room 50 for remotely controlling signal routing and connectivity and/or quality of service (QOS) and/or streaming is provided. Thus, a professional in the master control/signal routing control room 50 can respond to events where streaming signal transportation effects the quality of the received signals by controlling signal routing with a control console 52. The control console 52 is connected to the streaming server 54. As mentioned earlier, the streaming server 54 receives the mixed audio signal as generated by the sound mixer 30 and forwarded by the signal processing device 38. The streaming server 54 further receives video signal streams as provided by the video camera(s) of the presenter side system. Preferably, mobile control devices 56 are provided that are configured to provide a user interface for controlling signal routing and/or video mixing on the streaming server 54. The mobile control devices 56 are connected to streaming server 56 directly through mobile internet connection. Video production is also performed remotely by a video engineer or by an operator in the master control room 50 as a manual customized professional service.

In the master control room 50, an operator cannot only control signal routing depending on bandwidth etc. but also video engineering via the signal routing control console 52. Video engineering includes in particular controlling the camera(s) 32 and the selection of video signals provided by the camera(s) 32 for streaming to the audience-site system. Controlling the camera(s) 32 preferably includes controlling the orientation of the camera, the zoom of an individual camera and the focus of an individual camera. Via the control console 52, an operator can also add overlays to the video images to be streamed to the audience-site system 12.

The mixing control room 36 and the signal routing control room 50 can be part of a common master control room.

Important aspects of the invention are:
1. Remote Expert Services coming from MCR (Master Control Room) or other remote locations where expert service providers are located
a. Master Control Room (MCR) functions (technical services, connectivity, add functions in live presentation)
   b. Remote access interfaces for expert service providers
   c. Interfaces to local system
   d. Interfaces to server functions
2. Options for live presentation/performance
   a. Presenter has a simple web-based console displayed on a smartphone with internet access allowing to
      i. Switch to expert services/route them in
      ii. Switch/control server functions
      iii. Switch control local system

### REFERENCE SIGNS

10 presenter-side system
12 audience-side system
14 live stream receiver
16 audience side loudspeakers
18 screen
20 data communication network
22 smartphone
24 microphone
26 preamplifier
28 analog to digital converter
30 digital mixer
32 digital video camera
34 remote control console
36 mixing control system/mixing control room
38 streaming data gateway
40 signal processing device
42 screen
44 monitoring loudspeakers
46 mobile device
48 lightning equipment
50 master control room/signal routing control room
52 signal routing control console
54 streaming server
56 control devices
58 bi-directional audio and/or video connection
60 communication channel
62 control signal channel
64 head set
66 backend server

1. A real-time video streaming system comprising:
a presenter-side system with
at least one video camera,
a plurality of microphones and/or sound pick-ups,
a remote controlled sound mixer with a plurality of audio signal inputs, at least one audio signal output and a control interface,
a streaming data gateway including a video signal interface and an audio signal interface and comprising a codec for generating a digital video stream to be transmitted via a data network, said video stream representing video signals recorded by the camera and audio signals representing mixed audio signals provided by the sound mixer,
a remote control gateway connected to a remote control console for remotely controlling the sound mixer via the control interface of the sound mixer,
a mixing control system remotely connected to the presenter-side system comprising the remote control console for remotely operating the sound mixer by a sound engineer in a control room,
a bi-directional audio connection between the mixing control system and the presenter-side system enabling a sound engineer in the control room to listen to the mixed audio stream generated by the sound mixer and/or individual signals from individual microphones and/or sound pick-ups, and
an audience-side system comprising a digital signal receiver comprising a codec for decoding the digital video stream and video screen and loudspeakers at least in-directly connected to the digital signal receiver.

2. The video streaming system according to claim 1, wherein the streaming data gateway is incorporated in a signal-processing device comprising audio and video signal interfaces and one or more digital data interfaces, at least one of them being connected to a modem for generating, transmitting and receiving data streams.

3. The video streaming system according to claim 1, wherein the streaming data gateway is configured for bidirectional audio video data streaming.

4. The video streaming system according to claim 3, wherein the streaming data gateway comprises a bidirectional data modem for transmitting and receiving data signal streams, said data modem being connected to a decoder for decoding an audio video signal data stream received via the data modem.

5. The video streaming system according to claim 1, wherein for each microphone and/or pick-up, an analog preamplifier and an analog to digital converter are provided that generate digital sound signals to be fed to the inputs of the sound mixer.

6. The video streaming system according to claim 1, wherein the video camera in the presenter-side system is a digital video camera that provides a digital video signal stream when in use.

7. The video streaming system according to claim 1, wherein the sound mixer is a digital sound mixer having a plurality digital audio signal inputs and at least one digital video signal input, said sound mixer further having a digital control interface and being configured to be remotely controlled by control signals generated by the remote control console and received via the digital control interface, said digital control interface being part of the control gateway of the sound mixer.

8. The video streaming system according to claim 1, wherein the sound mixer is configured for mixing a plurality of audio signal streams and at least one video signal stream.

9. The video streaming system according to claim 2, wherein the sound mixer is integrated in the signal processing device.

10. The video streaming system according to claim 1, further comprising a signal routing control room for remotely controlling the streaming data gateway and preferably all other functions like router/onboard computer and overseeing streaming server/connectivity and other internet connections.

11. The video streaming system according to claim 1, further comprising one or more lightning devices that can be remotely controlled.

12. The video streaming system according to claim 1, wherein in the presenter-side system monitoring loudspeakers and a video screen are provided.

13. The video streaming system according to claim 12, wherein the monitoring loudspeakers are connected to the streaming data gateway.

14. The video streaming system according to claim 1, wherein in the presenter-side system a mobile device is provided that is configured to provide a user interface for operating the video camera in the presenter-side system.

15. A method of remote production of a live-like presenter's act comprising:
Performing a live-act at a presenter-side location;
converting sound signals of the live act in to digital sound signals;
mixing the digital sound signals by means of a remote controlled digital sound mixer;
remotely controlling the digital sound mixer by means of a remote control console in a mixing control room at a location that is remote from the location of the live act;
streaming the mixed audio stream generated by the digital sound mixer to the mixing control room and the an audience-side system at a third remote location; and
technical supervision of production, connections, signal routing and technical systems.
